(19) United States
(12) Patent Application Publication
(10) Pub. No.: US 2024/0235712 A1
(43) Pub. Date: Jul. 11, 2024

(54) METHOD FOR FORWARDING SYNCHRONIZATION INFORMATION IN A COMMUNICATION DEVICE, COMMUNICATION DEVICE AND VEHICLE

(71) Applicant: Continental Automotive Technologies GmbH, Hannover (DE)

(72) Inventors: Thomas Reisinger, Regenstauf (DE); Ulrich Emmerling, Kelheim (DE)

(73) Assignee: Continental Automotive Technologies GmbH, Hannover (DE)

(21) Appl. No.: 18/290,731

(22) PCT Filed: Jun. 27, 2022
(86) PCT No.: PCT/DE2022/200142

§ 371 Date: Jan. 19, 2024

(30) Foreign Application Priority Data
Jul. 20, 2021 (DE) 10 2021 207 759.5

(51) Int. Cl. H04J 3/06; H04W 56/00

(52) U.S. Cl. CPC H04J 3/0685; H04W 56/0015

(57) ABSTRACT

The communication apparatus has at least two transceiver units. One of the transceiver units receives in a predetermined ranging session a time signal from an external device unit, which time signal comprises a device clock state of the device unit at a reference time in a device time zone. The receiving transceiver unit generates a synchronization dataset describing a time relationship between an apparatus clock state at the reference time in the apparatus time zone and the device clock state at the reference time in the device time zone. The receiving transceiver unit initiates a synchronization session, in which the receiving transceiver unit defines a synchronization time grid which has a periodically repeating synchronization block, which provides a session round. In a predetermined session slot of the session round of the periodically repeating synchronization block, the receiving transceiver unit transfers the synchronization dataset to the others of the transceiver units.

The invention relates to a method for forwarding synchronization information in a communication apparatus that has at least two transceiver units. The invention also comprises a communication apparatus that has at least two transceiver units, and comprises a vehicle which has a communication apparatus.

According to the current prior art, vehicle locking systems are increasingly equipped with communication apparatuses that are configured to facilitate unlocking and/or locking of a vehicle via radio signals. The communication apparatuses generally use ultra-wideband technology UWB for this purpose. In order to unlock and/or lock the vehicle by radio, the communication apparatus communicates with a device unit carried by a driver of the vehicle. For example, the device unit can be a radio key or a smartphone that has a UWB interface. It is common practice that vehicles can be unlocked or locked only from predetermined positions in relation to a respective vehicle. For example, it can be intended that the device unit must be within a predetermined range in front of a door of the vehicle.

In order to facilitate unlocking or locking according to a position of the device unit in relation to the vehicle, it is common practice for the communication apparatus to locate the position of the device unit via UWB signals. The locating of the device unit usually involves determining the time of flight of the UWB signals exchanged between the communication apparatus and the device unit. In order to be able to ascertain the position of the device unit by determining the time of flight, the communication apparatus has a plurality of transceiver units, also referred to as anchors. These transceiver units are situated in different positions on the vehicle. It is possible to ascertain the exact position of the device unit by capturing the times of flight between the device unit and the respective transceiver units.

In order to be able to minimize the energy consumption of the device unit and the communication apparatus, it is usual to assign to the individual transceiver units predetermined time windows in which the transceiver units are set to receive, and can receive UWB radio signals. Outside the time windows, the transceiver units are not set to receive and cannot receive any UWB radio signals. These time windows are defined by a ranging time grid set by the device unit, with a respective time slot in the ranging time grid allocated to each of the transceiver units. Since the respective transceiver unit can receive the UWB signals only within the assigned time window, it is necessary to perform accurate time synchronization between the device unit and the individual transceiver units.

This synchronization is required because the device unit and the individual transceiver units of the communication apparatus are in different time zones. The time zones are set for the device unit by the device clock, and for the transceiver units by a device clock of the communication apparatus. The clocks typically comprise a respective crystal oscillator. The time zones can diverge as a result of differences in the running times between the device clocks caused by the different quartz crystals. To be able to ensure synchronization over a period of time, it is necessary to update regularly and forward to the individual transceiver units synchronization information that links the time zone of the device unit to the time zone of the transceiver units.

It is therefore an object of the invention to provide a method that facilitates synchronization by means of forwarding synchronization information in the communication apparatus.

A first aspect of the invention relates to a method for forwarding synchronization information in a communication apparatus that has at least two transceiver units. In particular, the communication apparatus can be a communication apparatus for transmitting and receiving UWB radio signals. The communication apparatus can be provided to send and/or receive the UWB radio signals in order to facilitate radio-based closing and opening of a locking mechanism of a vehicle. The at least two transceiver units can be situated at different locations on the vehicle. The transceiver units can be provided to receive the UWB radio signals from an external device unit, which can be, for example, a cell phone or a radio key, and to ascertain from a signal strength and/or a time of flight of the UWB radio signals a distance between the respective transceiver unit and the device unit. The communication apparatus can be provided to ascertain a position of the device unit in a predetermined ranging session from the captured times of flight and/or the captured signal strengths at the transceiver units of the UWB radio signals. This ranging session is performed repeatedly. In the method, it is provided that the at least two transceiver units are synchronized to an apparatus time zone by a predetermined synchronization method using an apparatus clock of the communication apparatus. In other words, it is provided that the at least two transceiver units are synchronized to an apparatus time zone set by the apparatus clock. For example, the apparatus clock can be a mechanism that has a crystal oscillator. It is provided that one of the transceiver units receives in the predetermined ranging session a time signal from an external device unit, which time signal comprises a device clock state of the device unit at a reference time in a device time zone. In other words, it is provided that one of the transceiver units receives in the predetermined ranging session, in order to determine a distance between the transceiver unit and the device unit, the time signal in which is disclosed the device clock state that the device unit has in the device time zone at a predetermined reference time.

In the method, it is provided that the receiving transceiver unit generates at each ranging session a synchronization dataset, which describes a time relationship between an apparatus clock state at the reference time in the apparatus time zone and the device clock state at the reference time in the device time zone. In other words, it is provided that the transceiver unit which receives the time signal determines the current synchronization dataset. The synchronization dataset describes the time relationship between the apparatus clock state and the device clock state at the reference time. This defines an association between the device time zone and the apparatus time zone.

The receiving transceiver unit initiates a synchronization session, in which the receiving transceiver unit defines a synchronization grid which has a periodically repeating synchronization block, which has a session round. It is provided that the receiving transceiver unit initiates a synchronization session. In other words, it is provided that the receiving transceiver unit starts, in parallel in time with the ranging session, a synchronization session, which is intended to facilitate regular transmission of the current synchronization dataset for synchronizing the transceiver units. The receiving transceiver unit defines here a synchronization time grid that has a periodically repeating synchronization block. Thus the synchronization session has a dedicated synchronization time grid, which differs from a ranging time grid of the ranging session. The synchronization block is repeated periodically and comprises the session round. During predetermined session slots of the session round of the periodically repeating synchronization block, the synchronization dataset is transferred to the others of the transceiver units. In other words, it is provided that the transceiver unit delivers synchronization datasets on a regular basis. In this process, the synchronization dataset is transferred to the others of the transceiver units in a predetermined session slot of the session round. The transceiver units are configured to be set up to receive and/or send the synchronization dataset in the session rounds and/or the session slots. In the remaining time, the receiving and/or sending of the synchronization dataset can be deactivated. The invention provides the advantage that a dedicated synchronization session that is independent of the ranging session is configured for synchronizing the transceiver units. A particular advantage here is that a time length of the session slots of the ranging session is not extended by the transfer of the synchronization dataset.

The invention also includes developments that result in further advantages.

A development of the invention provides that when the synchronization session is initiated, the receiving transceiver unit sets the at least one further transceiver unit of the transceiver units to a receive mode in order to receive the synchronization dataset. In other words, it is provided that at the start of the synchronization session, the other of the transceiver units is set to the receive mode, in which the at least one further transceiver unit of the transceiver units is configured to receive the synchronization dataset continuously over time. The transceiver units can be shifted into the receive mode by a transfer of a predetermined signal. The other of the transceiver units can thus receive the first synchronization dataset throughout the entire receive mode. The receiving transceiver unit of the transceiver units sends the synchronization dataset to the other of the transceiver units in the predetermined session slot of the session round of the periodically repeating synchronization block. The other of the transceiver units receives the synchronization dataset, and derives from the predetermined session slot the synchronization time grid according to a predetermined alignment method. In other words, it is provided that the other of the transceiver units receives in the receive mode the synchronization dataset by the receiving transceiver unit of the transceiver units. The other of the transceiver units can determine from the time of reception the synchronization time grid that is applied in the synchronization session. The other of the transceiver units is thereby informed of the structure of the synchronization time grid and the predetermined session slot that it is assigned. The other of the transceiver units can ascertain by the synchronization time grid the time at which the next session round of the synchronization time grid begins. The enhancement provides the advantage that the synchronization time grid can be transferred to the other of the transceiver units by delivery of a simple signal.

A development of the invention provides that the receive mode is deactivated by the at least one further transceiver unit of the transceiver units after receiving the first synchronization dataset, and is activated in a next session round of the periodically repeating session block. In other words, it is provided that the receive mode of the further transceiver unit of the transceiver units is deactivated as soon as this unit has received the first synchronization dataset. This is possible because it has been informed of the synchronization time grid by means of the time at which the first synchronization dataset was received. It can hence derive at what time in the next session block the further synchronization dataset will be delivered. In order to save energy, the receive mode is not activated until in a next session round of the periodically repeating session block. This provides the advantage that the further synchronization datasets can be received without having to enable a continuous receive mode.

A development of the invention provides that one of the transceiver units receives a further time signal from a further external device unit, which further time signal comprises the respective device clock state of the respective further device unit at a respective further reference time in the device time zone. It is provided here that the transceiver unit generates a respective further synchronization dataset, which describes a respective time relationship between the apparatus clock state at the respective further reference time in the apparatus time zone and the respective further device clock state at the respective further reference time in the respective further device time zone. In a predetermined respective further session slot of the session round of the periodically repeating synchronization block, the transceiver unit transfers the synchronization dataset to the others of the transceiver units. In other words, it is provided that one of the transceiver units receives a further time signal. Like the time signal from the first device unit, this further time signal can describe the respective device clock state of the further device unit at a further reference time in the device time zone. For the device time zone of the further device unit, the transceiver unit can generate a further synchronization dataset, which can describe the respective time relationship between the apparatus clock state at the respective further reference time in the apparatus time zone and the respective further device clock state. It is possible that the additional synchronization dataset is transferred in the synchronization session. For this purpose, in order to deliver the additional synchronization dataset, said dataset is assigned in the synchronization grid a dedicated session slot in the session round. It is thereby possible to facilitate the transfer of further synchronization datasets from respective transceiver units by assigning respective session slots in the session round to the further transceiver units for transferring the synchronization datasets that they have generated.

A development of the invention provides that in the synchronization dataset, the device clock state at the reference time in the device time zone is given as a block index of a synchronization block of the ranging session, which synchronization block starts or ends at the reference time. In other words, the time of the reference time in the device time zone is not given by a time value but by the index of the block that starts or ends at the reference time of the ranging session. This provides the advantage that the device clock state is given by a value that has a smaller size than a clock time. The association of the device clock state with a block index is possible because a ranging time grid of the ranging session is set by the device time zone of the device unit.

A development of the invention provides that the synchronization dataset sent out by one of the transceiver units is received by a transceiver unit of the transceiver units that is acting as a relay transceiver unit, and is sent to the further transceiver unit of the transceiver units by the transceiver unit of the transceiver units that is acting as the relay transceiver unit. In other words, it is provided that an indirect transfer can take place of the synchronization dataset sent out by one transceiver unit to another of the transceiver units via a transceiver unit acting as a relay transceiver unit. This provides the advantage that the synchronization dataset can be provided to the transceiver unit even if it is not possible to transfer the synchronization dataset directly from the transmitting transceiver unit. For example, a direct transfer between two of the transceiver units may not be possible temporarily or permanently. In order to facilitate transfer of the synchronization dataset nonetheless, it can be provided that the transceiver unit that generated the synchronization dataset sends the synchronization dataset in a first step to the transceiver unit that is meant to act as a relay transceiver unit. The transceiver unit acting as a relay transceiver unit can relay, in a second step, the synchronization dataset it received to the transceiver unit that is meant to receive the synchronization dataset. It can also be provided that the synchronization dataset is relayed via more than one of the transceiver units. The number of the relay transceiver units that have relayed the dataset can be given as a value of a relay counter.

A development of the invention provides that the synchronization dataset has an age value, which age value describes the number of blocks since the synchronization dataset was generated. In other words, it is provided that the age value describes the number of blocks of the synchronization time grid before which the respective synchronization dataset was generated. The development provides the advantage that a reliability and/or currentness of the respective synchronization dataset can be ascertained. The transceiver units can thereby adjust, for example, a time length of the time intervals in which they are in receive mode according to the reliability and/or currentness of the synchronization dataset. For example, it can be provided that a time window of certainty, which describes a time interval before a time slot and/or after a time slot in which the receive mode is additionally activated, has a length that depends on the age value of the synchronization dataset. For example, this can compensate for the fact that a synchronization that took place a long time ago is less accurate than a current synchronization.

A development of the invention provides that a fresh synchronization dataset is received by one of the transceiver units, and the age value of the fresh synchronization dataset is compared with an age value of a synchronization dataset stored in the transceiver unit. In other words, it is provided that the transceiver unit stores the received or generated synchronization dataset. This synchronization dataset has the respective age value. If the transceiver unit receives the fresh synchronization dataset, the age value of the fresh synchronization dataset is compared with the age value of the stored synchronization dataset. In other words, by means of the method, the transceiver unit determines which of the synchronization datasets it has available is older. It is provided that the synchronization dataset stored in the transceiver unit is overwritten by the fresh synchronization dataset if the age value of the fresh synchronization dataset indicates a younger age than the age value of the synchronization dataset. In other words, the stored synchronization dataset is overwritten by the fresh synchronization dataset if the fresh synchronization dataset is younger than the stored synchronization dataset. This provides the advantage that a stored synchronization dataset is only overwritten by a fresh synchronization dataset if the fresh synchronization dataset is younger than the stored synchronization dataset. This can ensure that, in the event that an older synchronization dataset is relayed via a plurality of relay transceiver units, replacement of a younger dataset stored in the transceiver unit by an older dataset is prevented.

A second aspect of the invention relates to a communication apparatus having at least two transceiver units. For example, the communication apparatus can be a radio facility of a locking system of a vehicle. The at least two transceiver units can be configured to send and/or receive radio signals during a ranging session in order to ascertain a distance to a device unit. The communication apparatus is configured to synchronize the at least two transceiver units to an apparatus time zone by a predetermined synchronization method using an apparatus clock of the communication apparatus. In other words, the communication apparatus has an apparatus clock that is configured to set an apparatus time zone. The communication apparatus is configured to synchronize the at least two transceiver units with the apparatus clock, so that the two transceiver units work in the apparatus time zone set by the apparatus clock. The communication apparatus is configured to receive by one of the transceiver units in a predetermined ranging session from an external device unit a time signal that comprises a device clock state of the device unit at a reference time in a device time zone. In other words, it is provided that the transceiver unit is configured to perform the predetermined ranging method in a predetermined ranging session in order to determine a distance of the transceiver unit from an external device unit. The external device unit can be a radio key or a cell phone, for example. The transceiver unit is configured to receive the time signal that was received from the device unit. The time signal here comprises a device clock state of a device clock of the device unit at a reference time in the device time zone. In other words, the time signal comprises a state of a device clock of the device unit. The device clock state was read at a reference time. The device time zone can differ from the apparatus time zone, however. So that the two clock states can be associated with each other, it is provided that the communication apparatus is configured to generate by the receiving transceiver unit a synchronization dataset, which describes a time relationship between an apparatus clock state at the reference time in the apparatus time zone and the device clock state at the reference time in the device time zone. In other words, the transceiver unit is configured to create the synchronization dataset, which makes it possible to associate the device time zone with the apparatus time zone. For this purpose, the synchronization dataset has the time relationship comprising the apparatus clock state that the apparatus clock has in the apparatus time zone at the reference time, and associates this with the device clock state of the device time zone. The communication apparatus is configured to initiate by the receiving transceiver unit a synchronization session, in which the receiving transceiver unit defines a synchronization time grid having a periodically repeating synchronization block. In other words, the communication apparatus is configured to transfer, by means of the predetermined synchronization session, the synchronization dataset from the generating transceiver unit to the others of the transceiver units, which transfer is carried out in the synchronization session, which has a predetermined synchronization time grid. The synchronization time grid comprises the predetermined synchronization block, which is divided into individual session rounds. The communication apparatus is provided to transfer by the receiving transceiver unit in the predetermined session slot of the session round of the periodically repeating synchronization block the synchronization dataset to others of the transceiver units. In other words, it is provided that in the session slot assigned to the transceiver unit, the synchronization dataset is sent by the transceiver unit to the other of the transceiver units.

A third aspect of the invention relates to a vehicle having a communication apparatus. The vehicle can be a passenger vehicle, for example, having a locking mechanism that can be configured to unlock a door of the vehicle according to a located position of a device unit.

The invention also includes developments of the communication apparatus according to the invention and of the vehicle according to the invention that have features such as have already been described in connection with the developments of the method according to the invention. For this reason, the corresponding developments of the communication apparatus according to the invention and of the vehicle according to the invention are not described again here.

The invention also encompasses the combinations of the features of the embodiments described.

An exemplary embodiment of the invention is described below, in which regard:

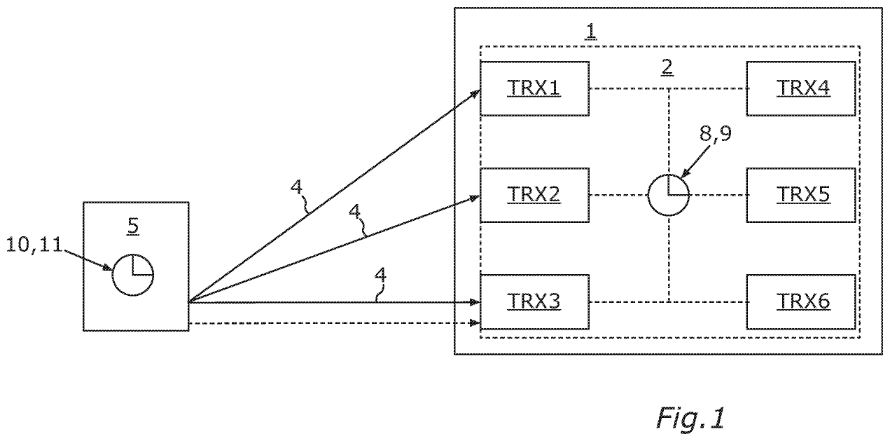

FIG. 1 shows a schematic representation of a vehicle having a communication apparatus;

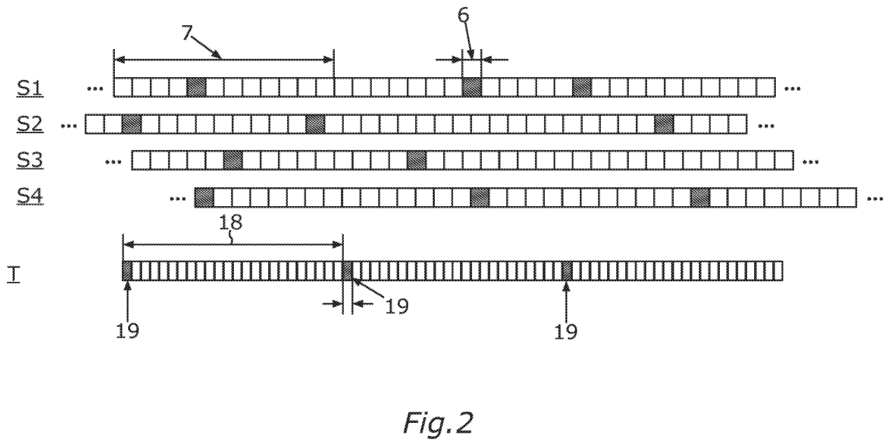

FIG. 2 shows a schematic representation of a synchronization time grid and a plurality of ranging time grids for respective ranging sessions;

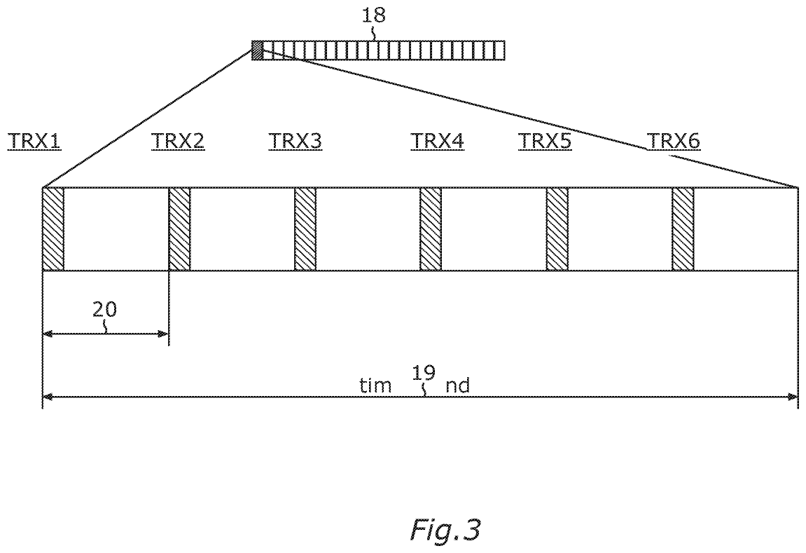

FIG. 3 shows a schematic representation of a division of the synchronization grid;

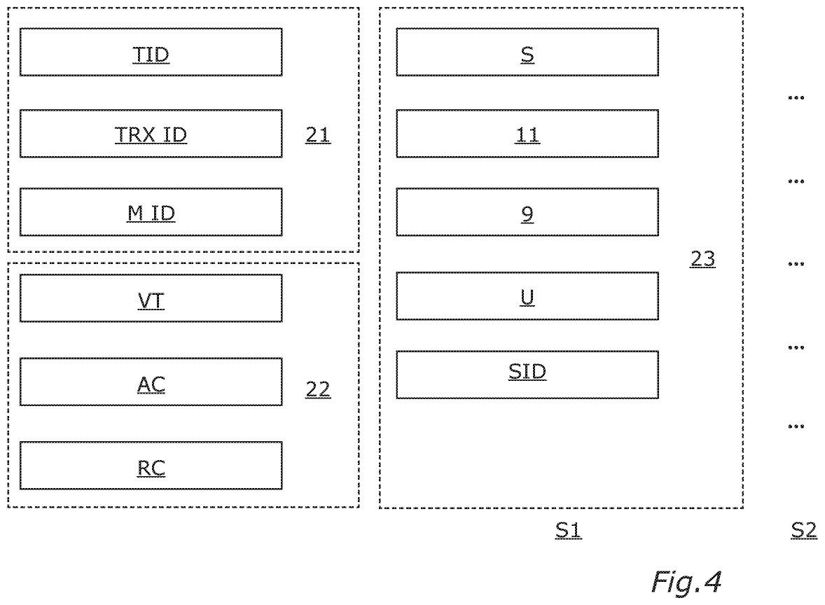

FIG. 4 shows a schematic representation of a possible structure of the delivered synchronization datasets;

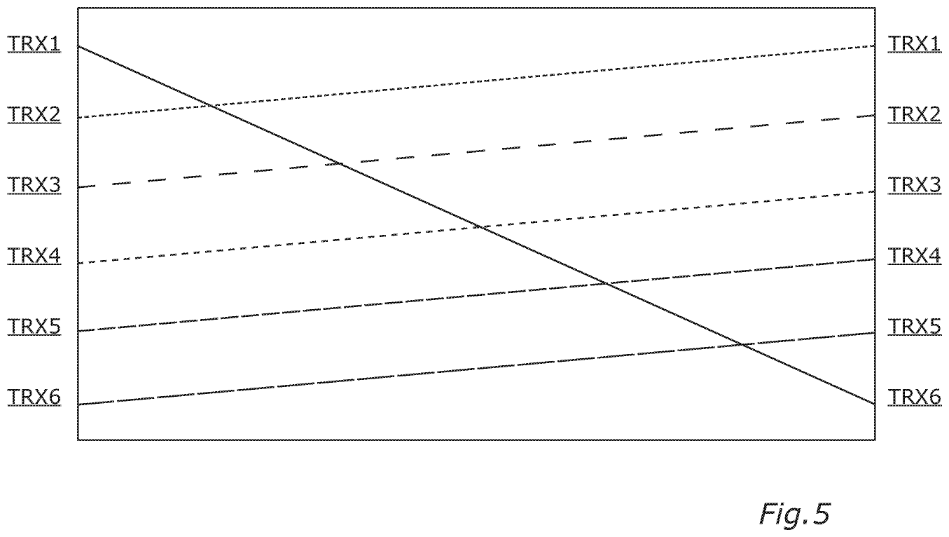

FIG. 5 shows possible transfer paths between individual transceiver units of the transceiver units, where direct transfers can take place between two of the transceiver units;

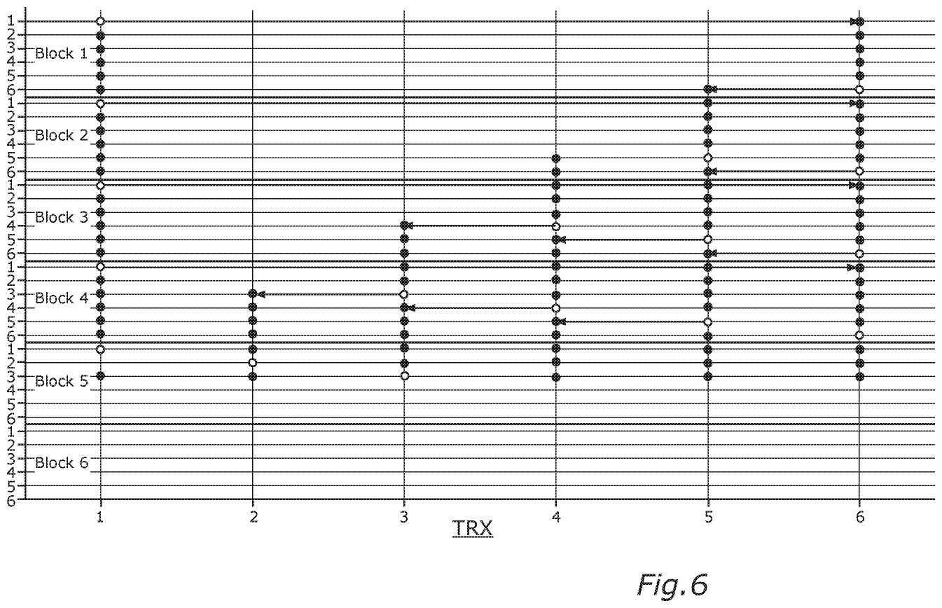

FIG. 6 shows a schematic representation of available direct connections between the transceiver units; and

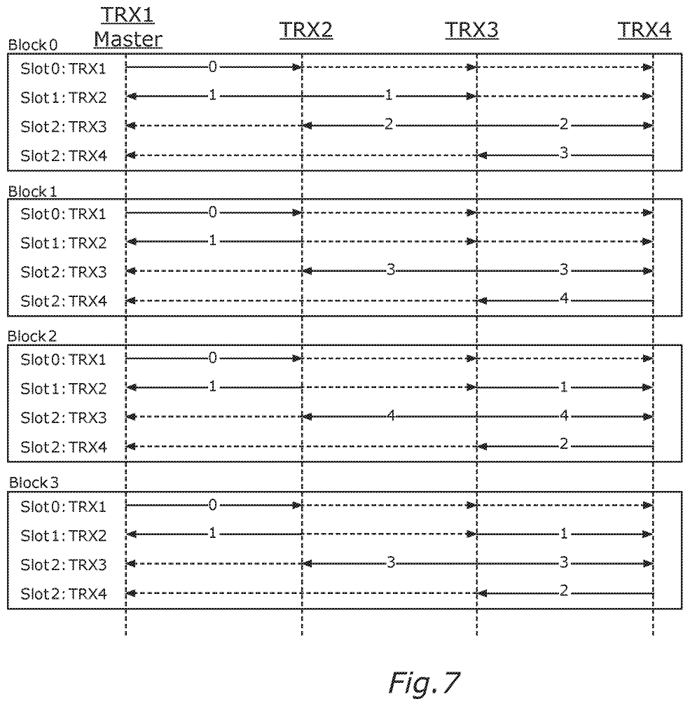

FIG. 7 shows a schematic representation of a sequence for the transfer of the synchronization datasets in what is referred to as a relay method.

The exemplary embodiment explained below is a preferred embodiment of the invention. In the exemplary embodiment, the described components of the embodiment each represent individual features of the invention that should be considered independently of one another and that each also develop the invention independently of one another and can therefore also be considered to be part of the invention individually or in a combination other than that shown. Furthermore, the embodiment described may also be supplemented by further features of the invention that have already been described.

The device unit and the transceiver units can have a computing unit. A computing unit can be understood to mean in particular a data processing device; thus the computing unit can process in particular data for performing computing operations. This includes, if applicable, also operations for performing indexed accesses to a data structure, for instance to a look-up table (LUT).

In particular, the computing unit can contain one or more computers, one or more microcontrollers, and/or one or more integrated circuits, for example one or more application-specific integrated circuits (ASIC), one or more field-programmable gate arrays (FPGA), and/or one or more systems on a chip (SoC). The computing unit can also contain one or more processors, for example one or more microprocessors, one or more central processing units (CPU), one or more graphics processing units (GPU), and/or one or more signal processors, in particular one or more digital signal processors (DSP). The computing unit can also contain a physical or virtual cluster of computers or others of the units mentioned.

In various exemplary embodiments, the computing unit contains one or more hardware and/or software interfaces and/or one or more memory units.

A memory unit can be in the form of a volatile data memory, for example a dynamic random access memory (DRAM) or a static random access memory (SRAM), or a non-volatile data memory, for example a read-only memory (ROM), a programmable read-only memory (PROM), an erasable read-only memory (EPROM), an electrically erasable read-only memory (EEPROM), a flash memory or flash EEPROM, a ferroelectric random access memory (FRAM), a magnetoresistive random access memory (MRAM), or a phase-change random access memory (PCRAM).

In the figures, elements with the same function are each provided with the same reference signs.

FIG. 1 shows a schematic representation of a vehicle 1 that has a communication apparatus 2. The communication apparatus 2 can have transceiver units TRX, which can be configured to send to a device unit 5 and/or receive from the device unit 5 predetermined ranging signals 4 in order to be able to ascertain in a predetermined ranging session S a distance between a respective transceiver unit TRX and the device unit 5. It can be provided that the respective transceiver units TRX send and/or receive the ranging signals 4 in respective ranging time windows 6. The ranging time windows 6 can be set in a ranging time grid of the ranging session S7. It can be provided that, in order to save energy, the respective transceiver units TRX can be set to a ranging receive mode only in their respective ranging time windows 6 of the ranging time grid 7. In order to ascertain the ranging time windows 6, the communication apparatus 2 can have an apparatus clock 8, which can set an apparatus time zone 9. The apparatus clock 8 can be configured as a crystal clock, for example. The individual transceiver units TRX can be synchronized with the apparatus clock 8 and hence can work in the same apparatus time zone 9. The device unit 5 can have a device clock 10, which can set a device time zone 11, 14. So that it is possible for the device unit 5 to emit a ranging signal 4, and for the respective transceiver unit TRX to receive the ranging signal 4 in its allocated ranging time window 6, it can be necessary for the device unit 5 to be synchronized with the transceiver units TRX 4. The problem can arise here that a time difference can exist between the device time zone 11, 14 of the device unit 5 and the apparatus time zone 9 of the communication apparatus 2, which can result from different running times of the quartz crystals of the device clock 10 and the apparatus clock 8. In order to be able to maintain synchronization between the communication apparatus and the device unit 5, it can hence be necessary for regular synchronizations to take place between the communication apparatus 2 and the device unit 5. According to the prior art, it is provided for this purpose that the device unit 5 sends a time signal 12 to a transceiver unit TRX4 acting as a master transceiver unit TRX. The time signal 12 can comprise a device clock state 13 of the device clock 10 of the device unit 5 at a reference time T in the device time zone 11, 14. The transceiver unit TRX 4 can receive the time signal 12 and generate a synchronization dataset 15, which describes a time relationship between the apparatus clock state of the apparatus clock 8 at the reference time in the apparatus time zone 9 and the device clock state 13 of the device clock 10 at the reference time in the device time zone 11, 14. This makes it possible to give a reference time in both of the time zones. It can be necessary to transfer the synchronization information in the synchronization dataset 15 to the others of the transceiver units TRX 4. This can be carried out, for example, via radio. It must be ensured in this process, however, that synchronization time windows 16 of a synchronization session do not conflict with the ranging time windows 6 of the ranging session S. Another problem can arise from the need to avoid an unnecessarily large rise in the volume of data for synchronization between the individual transceiver units TRX when a plurality of device units 5 are communicating with the communication apparatus 2.

It is therefore provided that the master transceiver unit TRX of the transceiver units TRX initiates the synchronization session. In this process, the master transceiver unit TRX defines a synchronization time grid 17 that has a periodically repeating synchronization block 18. The synchronization block 18 itself has a session round 19, in which are located session slots 20, with a respective one of the session slots 20 being assigned to a respective transceiver unit TRX. It is provided that the transceiver units TRX set in the respective session slots 20 the synchronization time windows, in which the respective synchronization datasets 15 are sent and the transceiver units TRX are placed into a synchronization receive mode for receiving the synchronization datasets 15.

FIG. 2 shows a schematic representation of a synchronization time grid 17 and a plurality of ranging time grids for respective ranging sessions S. It shows ranging time grids “UWB Device Time” defined by the respective device units 5, which time grids define the ranging time windows 6 in which, during the ranging sessions S, ranging signals 4 can be exchanged between the respective device unit 5 and the communication apparatus 2 of the vehicle 1, and the transceiver units TRX can be placed into a ranging receive mode. It also shows the synchronization time grid 17 “Vehicle Time” defined by the master transceiver unit TRX, to which time grid all the transceiver units TRX are synchronized. The ranging sessions S S1 to S4 can be assigned to a respective device unit 5. A ranging time grid of a respective ranging session S can be set by the device time zone 11, 14 of the respective device unit 5. The ranging time grid of the respective ranging sessions S can have predetermined blocks, which can have a respective predetermined time length. Inside a block can be located a respective round, in which ranging can take place between the respective device unit 5 and the individual transceiver units TRX by exchanging ranging signals 4. For each additional device unit 5, it can be necessary to generate respective synchronization datasets 15, which must be sent by one of the transceiver units TRX to the others of the transceiver units TRX. For this purpose, a method must be provided that avoids an excessive increase in the amount of data being transferred and the associated increasing risk of a conflict between ranging time windows 6 of different ranging sessions S and synchronization time windows 16. It is therefore provided to initiate the predetermined synchronization session, in which are exchanged between the transceiver units TRX the respective synchronization datasets 15 required for the individual ranging sessions S. The synchronization grid can be set here by the master transceiver unit TRX and have a predetermined time length. A respective block can have a respective round, in which the individual transceiver units TRX can send out and receive in respective slots the synchronization datasets 15. The synchronization time grid 17 is set here by the master transceiver unit TRX. For example, this may be the transceiver unit TRX that has initiated the first ranging session S with one of the device units 5. In order to be able to inform the other transceiver units TRX of the synchronization time grid 17, it can be provided in a first step that the master transceiver unit TRX places the other transceiver units TRX into a continuous synchronization receive mode. While the other transceiver units TRX are in the synchronization receive mode, the master transceiver unit TRX can send the first synchronization dataset 15 to the individual transceiver units TRX. Since each of the transceiver units TRX is assigned a predetermined synchronization slot of the synchronization time grid 17, the transceiver units TRX can ascertain from a time at which the first synchronization dataset 15 is received the synchronization time grid, and hence determine the future receive times. After receiving the first synchronization dataset 15, the individual transceiver units TRX can go into the synchronization receive mode during the respective session slots 20, and deactivate the synchronization receive mode in a remaining one.

The idea relates to the vehicle-internal forwarding of the synchronization information “vehicle internal synchronization”, which a transceiver unit TRX, also known as an anchor, receives either by receiving a UWB packet or by the method called “BLE Timesync”. Both mechanisms are described in the CCC specification, and inform the anchor of the current time “UWBDeviceTime” in the time zone of the smartphone “Device”.

An object of the method is to transfer local time synchronization information into a synchronization dataset 15, which can be transferred to other transceiver units TRX in a manner that is not time-critical. The synchronization dataset 15 can comprise data tuples, which associate an apparatus clock state of the apparatus time zone 9 “Vehicle Time” with the device clock state 13 “Clock State” of the device time zone 11, 14 “UWB Device Time”. The synchronization dataset 15 can also comprise supplementary information. This supplementary information can comprise an uncertainty value Uncertainty and a source value S ID. The source value S ID can identify the transceiver unit TRX that has generated the synchronization dataset 15 Source.

It is provided that all the transceiver units TRX of the communication apparatus 2 are synchronized with the apparatus clock 8 of the communication apparatus 2. The transceiver units TRX can thus be assigned to the apparatus time zone 9 defined by the apparatus clock 8. The apparatus clock 8 can be synchronized by a control unit via a bus system or by a UWB session of the transceiver units TRX. A transceiver unit TRX consequently has two clocks acting as clock masters: the device clock 10 Device Clock and the apparatus clock 8 Vehicle Clock. Any one point in time t can be represented by a clock state Clock State in the two time zones: C_Devicet, C_Vehiclet. The synchronization dataset 15 can be distributed from the creating transceiver unit TRX to all the other transceiver units TRX via a bus system, for example the CAN bus. This can be done, for example, by means of direct distribution or central distribution via a control unit of a vehicle 1 ECU. A further option is radio-based distribution via UWB “UWB Timesync” or via other relay channels such as BLE or WLAN. Cyclical updating of the synchronization dataset 15 can be provided in the distribution.

The format of the synchronization dataset 15 can be compressed by omitting redundant or implicitly present information. The synchronization dataset 15 can state, for example, the relationship between the clock states as a difference “Offset” between the clock state of the device clock 10 and the clock state of the apparatus clock 8:

$$OffsetV - Dt = C\_Vehiclet - C\_Devicet$$

The clock state of the device clock 10 can be represented by means of a ranging time grid of the ranging session S MAC-Grid. In this case, the point in time can be translated to a fixed reference of the MAC-Grid block or round level. Instead of a time, the MAC-Grid quantities of the ranging time grid of the ranging session S can be transferred in this case. It can be provided that an unsynchronized anchor extrapolates an existing synchronization dataset 15 for a current device clock state 13.

For example, there may exist a synchronization dataset 15 that associates the apparatus clock state with the device clock state 13 at a point in time t1. If a device clock state 13 is needed for a later point in time t2, this can be calculated by the following formula:

$$C\_Devicet 2 = [ C\_Vehiclet 2 - C\_vehiclet 1 ] * C\_Devicet 1 * Clock\_skew$$

It can be provided that a range of uncertainty is calculated on the basis of an uncertainty value “Uncertainty”. Worst case assumptions worstcase for the relative path difference “Clock_skew” between the device clock 10 and the apparatus clock 8 can be made here or as an alternative. An estimate of the relative path difference between the device clock 10 and the apparatus clock 8 can be made on the basis of a plurality of synchronization datasets 15. The synchronization dataset 15 can be distributed via the CAN bus.

Another option is to transfer the synchronization datasets 15 via UWB “UWB-Timesync”.

In this case, a separate synchronization session can be initiated that can pool a distribution of the synchronization datasets 15 from all the ranging sessions S. It can hence be provided that the synchronization session is initiated in addition to the ranging sessions S. The synchronization session T can have the dedicated synchronization time grid 17, in which the transceiver units TRX exchange the synchronization datasets 15. In this synchronization session, the synchronization datasets 15 of different ranging sessions S can be exchanged. A ranging session S can exist for a respective device unit 5 to be located by the communication apparatus 2. The synchronization time grid 17 of the synchronization session can be selected independently of the ranging time grids of the ranging sessions S.

For the purpose of initiating the synchronization session, one of the transceiver units TRX can be specified as the master transceiver unit TRX. This defines the synchronization time grid 17 MAC Grid of the synchronization session. The synchronization time grid 17 of the synchronization session can have the apparatus time zone 9 as a reference. In contrast, the ranging time grid of the ranging sessions S is defined with reference to the device time zone 11, 14 of the respective device time zone 11, 14.

The transceiver unit TRX that has handled a first of the ranging sessions S can be determined to be the master transceiver unit TRX. The others of the transceiver units TRX adopt the synchronization time grid 17 defined by the master transceiver unit TRX and are known as slave transceiver units TRX. The slave transceiver units TRX transmit in their respective assigned time slots. A sequence for transmission by the transceiver unit TRX can be defined in advance in the communication apparatus 2, or specified dynamically during the initialization of the synchronization session by the master transceiver unit TRX. The synchronization session can be initialized in conjunction with the first ranging session S. For the synchronization session, the same parameters can be used for the physical layer Physical Layer as are used for the ranging session S. The master transceiver unit TRX can start the synchronization time grid 17 MAC Grid taking into account the start of the ranging session S. The transceiver units TRX which are slave-master transceiver units TRX switch into a continuous synchronization receive mode “scanning” at the start of the synchronization session until they receive the first synchronization dataset 15 of the synchronization session from the master transceiver unit TRX. The slave-master transceiver units TRX can use the receiving to ascertain the synchronization time grid 17 of the synchronization session. In the synchronization session, the latest synchronization datasets 15 from all the ranging sessions S can be sent out periodically. Each of the transceiver units TRX can manage its own table containing synchronization datasets 15, which can be updated by new synchronization datasets 15. The new synchronization datasets 15 can be those that were generated by the transceiver unit TRX itself or were received from another of the transceiver units TRX. Each of the transceiver units TRX can ascertain for new synchronization datasets 15, on the basis of the uncertainty value U, whether the new synchronization datasets 15 are more reliable than the existing synchronization dataset 15.

The transceiver units TRX can act as relay transceiver units TRX and pass on received synchronization datasets 15 to others of the transceiver units TRX.

Each of the transceiver units TRX transmits in its assigned synchronization time slot of the synchronization time grid 17. This can take place even if the master transceiver unit TRX is unable to receive directly. Each of the transceiver units TRX can ascertain the quality of its available synchronization time grid 17 of the synchronization session, which time grid is updated on receipt of a synchronization-session packet.

The quality of the synchronization time grid 17 of the synchronization session, which time grid is available to the transceiver unit TRX, is described by the time that has elapsed since receiving the last known synchronization dataset 15 from the master transceiver unit TRX, and the number of relay transceiver units TRX that have relayed the synchronization dataset 15 from the master transceiver unit TRX. A synchronization session log stored in a respective transceiver unit TRX, or a respective synchronization dataset 15, can comprise information about the quality of the synchronization time grid 17 of the synchronization session and an age value of a time length since last receiving from the master transceiver unit TRX “Timesync Grid Age”. The synchronization dataset 15 can also comprise a relay counter. This can state a number of the relay transceiver units TRX, and can specify the number of relay transceiver units TRX through which the synchronization dataset 15 has been relayed since being sent out by the master transceiver unit TRX “Relay Counter”.

A slave transceiver unit TRX can stop sending out periodically the synchronization datasets 15 if no other synchronization dataset 15 of the synchronization session has been received for a preset length of time, or the age value of the synchronization time grid 17 exceeds a preset value.

The master transceiver unit TRX can terminate the synchronization session if all the ranging sessions S have finished or the device unit 5 has not been received again for a preset time Timeout.

FIG. 3 shows a schematic representation of a division of the synchronization grid. It shows a synchronization block 18 of the synchronization grid, which can have a plurality of synchronization rounds. One of the synchronization rounds has a plurality of synchronization slots, where a respective synchronization slot can be assigned to a respective transceiver unit TRX. A sequence of the synchronization slots and the allocation of the transceiver units TRX can be determined in advance. A synchronization round can comprise delivering synchronization datasets 15, which can contain time associations between device time zones 11, 14 and apparatus time zones 9 for all the ranging sessions S.

The transceiver unit TRX1 can be the master transceiver unit TRX of the synchronization session and set the synchronization time grid 17. A determination of one of the transceiver units TRX as the master transceiver unit TRX, and a sequence of the slave transceiver units TRX can be preset in the communication apparatus 2, or can be assigned dynamically from one synchronization session to the next.

Each of the transceiver units TRX attempts to receive the synchronization datasets 15 from all the other transceiver units TRX in order to obtain the most up-to-date time relationships.

FIG. 4 shows a schematic representation of a possible structure of the delivered synchronization datasets 15.

A synchronization dataset 15 can comprise the time relationships for each ranging session S, and information about the Timesync Layer for the vehicle-based synchronization of the apparatus clock 8.

The format of the time relationships can be adapted in order to optimize the quantity of source data, or to omit redundant information. A device clock state 13 can be extrapolated to boundaries of a ranging session block or of a synchronization session block. It is sufficient here to transfer an index of the ranging session block or of the synchronization session block. Device clock states 13 and/or apparatus clock states, which have a high resolution in comparison, do not have to be transferred in this case. It can be provided that instead of a data tuple composed of the device clock state 13 and the apparatus clock state, only a difference between these two values is transferred as a time relationship “Offset”. Timesync Link Layer information can be omitted if this is already known through vehicle-based synchronization of the transceiver units TRX with the apparatus clock 8, e.g. Vehicle Clock synchronization via the CAN bus.

The synchronization dataset 15 can comprise a dataset header 21, synchronization time grid information 22 and synchronization data 23 of a synchronization session. A synchronization dataset 15 for a specific session can have a reference to the respective session, for example. The synchronization datasets 15 can also contain a current device clock state U T 13 U T of the device unit 5 and a current apparatus clock state V T V T of the communication apparatus 2. A respective synchronization dataset 15 can also comprise an uncertainty value U U, which can comprise, for example, measurement and/or estimation inaccuracies for a current time. The synchronization dataset 15 can also comprise a source value S ID S ID, which identifies the transceiver unit TRX that has generated the respective dataset. A relay counter R C R C can indicate the number of relay transceiver units TRX that have relayed the synchronization dataset 15. A value S can define the ranging session S. A synchronization session identifier T ID T ID can identify the synchronization session. An age value A C can give an age A C of the synchronization dataset 15. A master transceiver unit identifier M ID can indicate the master transceiver unit TRX of the synchronization session.

FIG. 5 shows possible transfer paths between individual transceiver units of the transceiver units TRX, where direct transfers can take place between two of the transceiver units TRX. If the distribution takes place via UWB or another wireless medium, then it is not guaranteed that each of the transceiver units TRX at any one time is able to receive the synchronization dataset 15 from another transceiver unit TRX. Scenarios can arise in which a synchronization dataset 15 reaches a certain transceiver unit TRX only by using the relay functionality of another of the transceiver units TRX. Latencies can arise in the delivery in this case. In the worst case scenario, one of the transceiver units TRX may be completely isolated from the other transceiver units TRX “isolated anchor”.

FIG. 6 shows a schematic representation of available direct connections between the transceiver units TRX. It shows a possible special case in which each of the transceiver units TRX can send synchronization datasets 15 only via a direct connection to another of the transceiver units TRX.

FIG. 7 shows a schematic representation of a sequence for the transfer of the synchronization datasets 15 in what is referred to as a relay method. It shows synchronization blocks 18 of the synchronization method and individual synchronization slots, and shows in the individual synchronization slots a respective transceiver unit TRX acting as a sender, and a respective transceiver unit TRX acting as a receiver of a synchronization dataset 15. A number shown on the arrows can give the age value of a respective dataset, or the number of re-routings made via relay transceiver units TRX.

It can be provided that in a first synchronization block 18, the synchronization dataset 15 is transferred from a transceiver unit TRX1 to a transceiver unit TRX2. A respective counter for the relay relayings can equal zero here. In a second slot, which can be assigned to the second transceiver unit TRX2, the synchronization dataset 15 can be transferred from the second transceiver unit TRX1 to the third transceiver unit TRX3 and the first transceiver unit TRX1, whereby the relay counter R C can assume the value 1. In a third slot, the transceiver unit TRX TR3 can deliver the synchronization dataset 15 to the transceiver unit TRX2 and the transceiver unit TRX4. In a fourth slot, the transceiver unit TRX4 can deliver the synchronization dataset 15 to the transceiver unit TRX3.

In the synchronization session block shown underneath, a connection between the transceiver unit TRX2 and the transceiver unit TRX3 can be broken. This means that the transceiver unit TRX3 cannot receive a fresh synchronization dataset 15. Thus there may be an out-of-date synchronization dataset 15 stored in the transceiver unit TRX3.

In a third synchronization session block, a connection between transceiver unit TRX2 and transceiver unit TRX3 may still be broken. In this synchronization session block, the transceiver unit TRX4 can receive the synchronization dataset 15 from transceiver unit TRX2.

Overall, the example shows how a method for forwarding synchronization information can be provided.

### LIST OF REFERENCE SIGNS

1 vehicle
2 communication apparatus
TRX transceiver unit
4 ranging signal
5 device unit
6 ranging time window
7 ranging session
8 apparatus clock
9 apparatus time zone
10 device clock
11 device time zone
12 time signal
13 device clock state
15 synchronization dataset
16 synchronization time window
17 synchronization time grid
18 synchronization block
19 session round
20 session slot
21 dataset header
22 synchronization time grid information
23 synchronization data for a synchronization session
R C relay counter
A C age value
V T current apparatus clock state
T ID synchronization session identifier
M ID master transceiver unit identifier
U uncertainty value
U T current device clock state
S ID source value
S ranging session

1. A method for forwarding synchronization information in a communication apparatus having at least two transceiver units, wherein the at least two transceiver units are synchronized to an apparatus time zone by a predetermined synchronization method using an apparatus clock of the communication apparatus, and one of the at least two transceiver units receives in respective predetermined ranging sessions a time signal from an external device unit, which time signal comprises a device clock state of the device unit at a reference time in a device time zone, the method comprising:
at the receiving transceiver unit, generating at each of the ranging sessions a synchronization dataset, which describes a time relationship between an apparatus clock state at the reference time in the apparatus time zone and the device clock state at the reference time in the device time zone,
at the receiving transceiver unit, initiating a synchronization session, in which the receiving transceiver unit defines a synchronization time grid in which a synchronization block is repeated periodically, in which a session round takes place, and
at the receiving transceiver unit, transferring in a predetermined session slot of the respective session round of the periodically repeating synchronization block a current synchronization dataset to at least one further transceiver unit of the at least two transceiver units.

2. The method as claimed in claim 1, wherein, when the synchronization session is initiated, the receiving transceiver unit sets the at least one further transceiver unit to a receive mode in order to receive a first synchronization dataset,
the at least one further transceiver unit receives the first synchronization dataset in the predetermined session slot of the session round of the periodically repeating synchronization block,
the at least one further transceiver unit derives from the predetermined session slot the synchronization time grid according to a predetermined alignment method, and ascertains a time of a next session round.

3. The method as claimed in claim 2, wherein the receive mode is deactivated by the at least one further transceiver unit after receiving the first synchronization dataset, and is activated in a next session round of the periodically repeating session block.

4. The method as claimed in claim 3, wherein one of the transceiver units receives from a further external device unit a respective further time signal, which further time signal comprises the respective device clock state of the respective further device unit at a respective further reference time in the device time zone,
wherein the transceiver unit generates a respective further synchronization dataset, which describes a respective time relationship between the apparatus clock state at the respective further reference time in the apparatus time zone and the respective further device clock state at the respective further reference time in the respective further device time zone,
the transceiver unit transfers in a predetermined respective further session slot of the session round of the periodically repeating synchronization block the synchronization dataset to the at least one further transceiver unit.

5. The method as claimed in claim 1, wherein, in the synchronization dataset, the device clock state at the reference time in the device time zone is given as a block index of a synchronization block of the ranging session, which synchronization block starts or ends at the reference time.

6. The method as claimed in claim 1, wherein the synchronization dataset is received by one of the transceiver units that is acting as a relay transceiver unit, and is sent to the at least one further transceiver unit by the transceiver unit of the transceiver units that is acting as the relay transceiver unit.

7. The method as claimed in claim 1, wherein the synchronization dataset has an age value, wherein the age value describes a number of blocks since the synchronization dataset was generated.

8. The method as claimed in claim 7, wherein a fresh synchronization dataset is received by one of the transceiver units,
the age value of the fresh synchronization dataset is compared with an age value of a synchronization dataset stored in the transceiver unit, and the synchronization dataset stored in the transceiver unit is overwritten by the fresh synchronization dataset if the age value of the fresh synchronization dataset is less than the age value of the synchronization dataset.

9. A communication apparatus comprising:
at least two transceiver units, wherein the communication apparatus is configured to synchronize the at least two transceiver units to an apparatus time zone by a predetermined synchronization method using an apparatus clock of the communication apparatus,
wherein the communication apparatus is configured to:
receive by one of the at least two transceiver units in a predetermined ranging session a time signal from an external device unit, which time signal comprises a device clock state of the device unit at a reference time in a device time zone,
generate by the receiving transceiver unit a synchronization dataset, which describes a time relationship between an apparatus clock state at the reference time in the apparatus time zone and the device clock state at the reference time in the device time zone,
initiate by the receiving transceiver unit a synchronization session, in which the receiving transceiver unit defines a synchronization time grid which has a periodically repeating synchronization block, which has a session round,
transfer by the receiving transceiver unit in a predetermined session slot of the session round of the periodically repeating synchronization block the synchronization dataset to at least one further transceiver unit.

10. A vehicle comprising a communication apparatus as claimed in claim 9.
